(19) United States
(12) Patent Application Publication
(10) Pub. No.: US 2011/0087560 A1
(43) Pub. Date: Apr. 14, 2011

(54) PAYMENT PROCESSING OVER THE INTERNET

(76) Inventor: Christopher John West, Chesapeake, VA (US)

(21) Appl. No.: 12/576,044

(22) Filed: Oct. 8, 2009

(51) Int. Cl. G06Q 20/00; G06Q 30/00

(52) U.S. Cl. 705/27.1

(57) ABSTRACT

A payment transaction is performed over the Internet. A merchant server presents to an end user a merchant web page that identifies the merchant server as the source of the web page. A payment processing server presents to the end user a web document that requests payment information from the end user. The web document is presented to the end user as an inline frame within the merchant web page.

### BACKGROUND

Electronic payments are frequently made over the Internet. In order to provide security protection for all electronic payments and the attendant personal financial data that is transmitted, utilized and stored, the Payment Card Industry (PCI) launched a universal standard called the Payment Card Industry Data Security Standard (PCI DSS). Information about the PCI DSS is available on the web site: https://www.pcisecuritystandards.org/security_standards/pci_dss. shtml.

The PCI DSS is intended to be comprehensive, aiding merchants in avoidance of all the common pitfalls that can make them vulnerable to a security breach. Merchant processing agreements typically require merchants to comply with the PCI DSS; therefore, a merchant's failure to comply with the PCI DSS may put the merchant in breach of their merchant processing agreement with their bank, may make the merchant substantially more vulnerable to security breaches or have other serious consequences.

For a merchant with a small to medium sized business, compliance with The PCI DSS can be a relatively costly undertaking. One solution is for the merchant to utilize an e-commerce business, such as Paypal or 2checkout, that facilitates payments over the Internet. However, this typically requires a shopper to visit websites hosted by these e-commerce businesses to make payments. It is desirable, therefore, to provide other ways to allow a merchant to comply with the PCI DSS in a cost effective manner.

### BRIEF DESCRIPTION OF THE DRAWING

FIG. 1 is a simplified block diagram illustrating how a payment processing server can work with a merchant server to provide cost effective payment transactions over the Internet.

FIG. 2 shows a merchant web page with an inline frame web document as viewed by an end user.

FIG. 3 shows a web page from a payment processing server that obtains information from the merchant in order to set up the web document that appears as the inline frame web document shown in FIG. 2.

FIG. 4 shows an example of a displayed web document that can be used by a merchant to make a payment previously authorized by an end user.

FIG. 5 shows an example of a web page that an end user can use to update payment information.

### DESCRIPTION OF THE EMBODIMENT

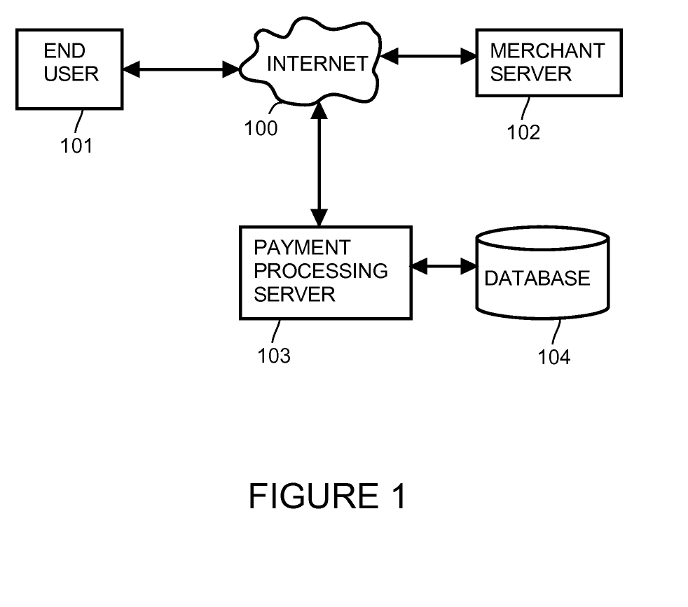

FIG. 1 shows an end user 101 in contact with a merchant server 102 through the Internet 100. If merchant server 102 is not compliant with the PCI DSS and yet the merchant still wants to allow end user 101 to make purchases using a credit card or other form of payment governed by PCI DSS, merchant server 102 can allow completion of a purchase re-directing end user 101 to a payment processing server 103 that is PCI certified. In this way, merchant server 102 can avoid handling cardholder data, which will flow directly and exclusively through payment processing server 103. Payment information and other information pertaining to end user 101 can be stored by payment processing server 103 in a database 104 that is directly accessible by payment processing server 103, but is not directly accessible by merchant server 102.

When end user 101 is in the process of making a purchase on the merchant's web page hosted by merchant server 102 and it is time to enter credit card information or other payment information, end user 101 will be directed to a different web page hosted by payment processing server 103. This can lead to shopper confusion, order abandonment and a loss of sales.

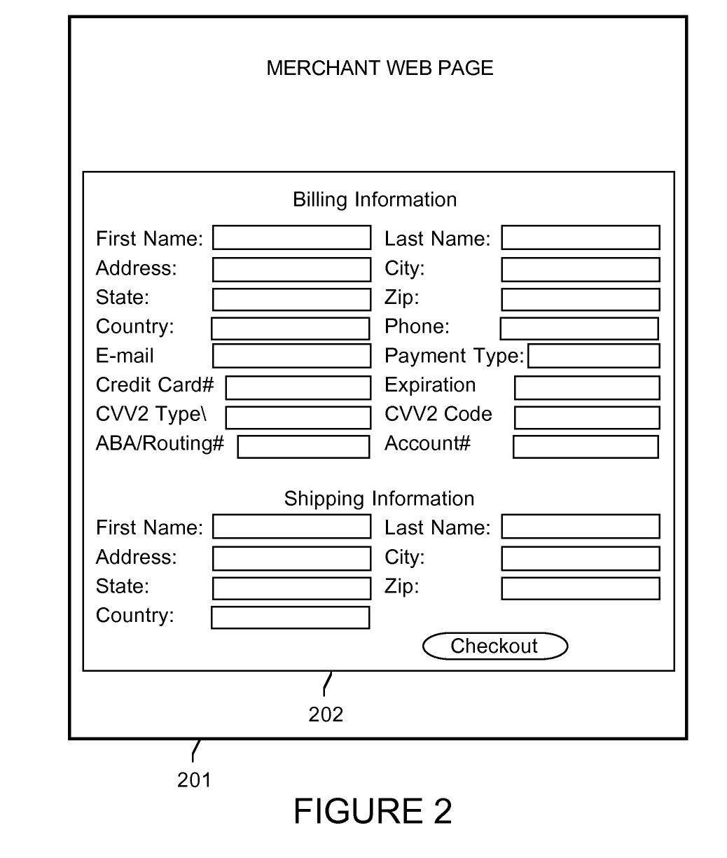

To avoid this potential confusion and resulting loss of sales, payment processing server 103 can obtain credit card information from a shopper through use of an inline frame placed within the merchant's web page hosted by web server 102. This is illustrated by FIG. 2.

FIG. 2 shows a merchant web page 201 as viewed by end user 101. Merchant web page 201 appears as a result of hypertext markup language (HTML) code stored on merchant server 102. Within merchant web page 201 is an HTML document 202 completely controlled by payment processing server 103.

The fields displayed by HTML document 202, as shown in FIG. 2, are exemplary and dependent upon the particular requirements of merchant server 102 and payment processing server 103. For example, information requested by HTML document can include credit card information, information for electronic transfer of funds, bank account information, etc. The information obtained from end user 101 can be stored within database 104 for future use.

HTML document 202 appears as an inline frame on merchant web page 201 as a result of an iframe tag embedded in the HTML code that implements merchant web page 201. When setting up the inline frame, merchant server 102 sends to payment processing server 103 an application programming interface (API) name and an API key. This allows payment processing server 103 to recognize the merchant and display HTML document 202 which is customized for the merchant. Merchant server 103 also sends a user identification, for example an internet protocol (IP) address, for end user 101. To promote security, merchant server 102 sends the API name, API key and user identification using special programming code so that the API name, API key and user identification are not viewable by end user 101.

An example of code utilized by merchant server 102 to send to payment processing server 103 the API name ($API_UNAME), API key ($API_KEY) and user identification (ID, CustomerID), allowing payment processing server 103 to set up HTML document 202 as an inline frame within merchant web page 201 is set out in Table 1 below:

TABLE 1
<?php
include_once(“quantum_iframe.php”);
$API_UNAME=“ABC”;
$API_KEY=“XYZ”;
##(API username, API Key, Width, Height, Amount, ID, CustomerID,

METHOD , AddToVault, SkipShipping)

// This does a simple request, posting 20.00 as value, and 10 as ID;

CustomerID, METHOD, AddToVauld, SkipShipping are not
posted are not posted in this sample, only the required fields are
set (API Username, API Key, width, height, amount, and ID)

$quantum = quantumilf_getCode($API_UNAME, $API_KEY, ‘800’,

‘800’, ‘20.00’, ‘10’);

?>
<!DOCTYPE html PUBLIC “-//W3C//DTD XHTML 1.0
Transitional//EN”

“http://www.w3.org/TR/xhtml1/DTD/xhtml1-transitional.dtd”>

<html xmlns=“http://www.w3.org/1999/xhtml”>
<head>
<meta http-equiv=“Content-Type” content=“text/html; charset=utf-8” />
<title>Some Document Here</title>
<?php echo $quantum[‘script’];?>
</head>
<body>
<?php echo $quantum[‘iframe’];?>
</body> </html>

The personal home page (php) scripting language code set out in Table 1 is not accessible to end user 101, but is called from the HTML code used by merchant server 102 to set up inline frame 202.

When payment processing server 103 receives from merchant server 102 the API name, API key and user identification, merchant 202 presents HTML document 202 to end user 101 and sends to merchant server 102 a randomly or pseudo randomly generated session identification (ID) number that will timeout and become invalid whenever a predetermined lapse of time, for example 120 seconds, passes without a transmissions from end user 101 indicating the session is still valid. The inline frame of merchant server 102 includes, for example, a JavaScript program that automatically sends a refresh signal to payment processing server 103 from end user 101 every 20 seconds to avoid timeout of the session ID number. Payment processing server 103 utilizes the session ID number and data from end user 101 in order to ensure payment processing server 103 processes the appropriate transaction for the correct merchant and end user.

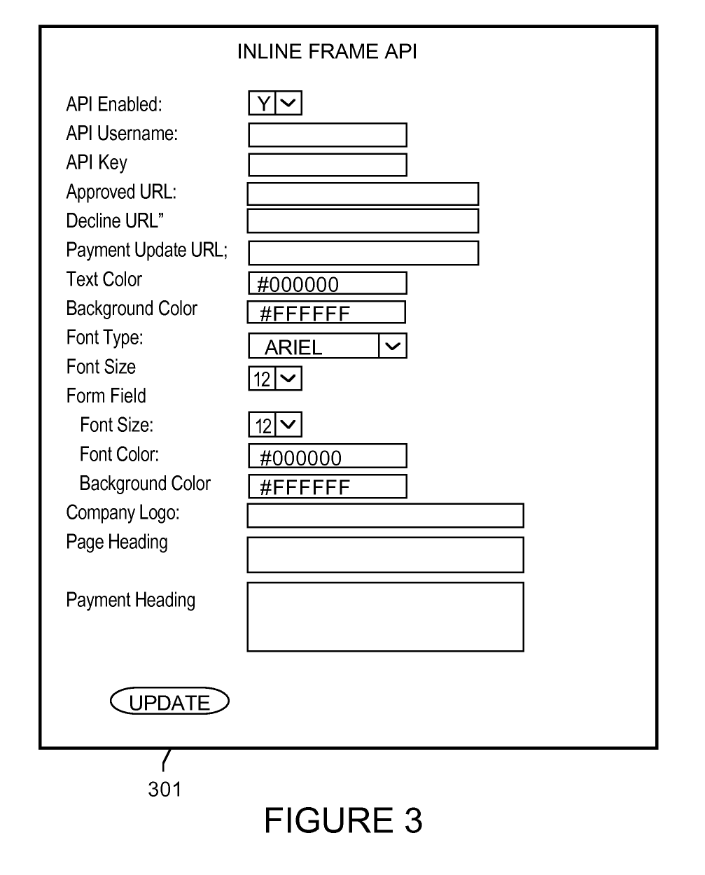

In order to enable payment processing server 103 to set-up HTML document 202 and generate an API name and API key for a merchant, payment processing server 103 obtains initialization information from the merchant, for example, using a web interface such as that shown in FIG. 3. As shown in FIG. 3, a web page 301 from payment processing server 103 is used to obtain information from the merchant in order to set up the application programming interface (API) for HTML document 202 that is displayed as an inline frame of merchant web page 201.

The API username field and API key are, for example, generated by payment processing server 103 and used by payment processing server 103 to identify the merchant. The approved universal resource locator (URL) field indicates a web page, typically hosted by merchant server 102, where end user 101 will be directed when a payment made by end user 101 is approved. The declined URL field indicates a web page, typically hosted by merchant server 102, where end user 101 will be directed when a payment made by end user 101 is declined. Payment update URL indicates a web page, typically hosted by merchant server 102, where end user 101 will be directed whenever end user 101 updates payment information stored by payment processing server 103 in database 104.

The fields labeled text color, background color, font type, font size, form field font size, form field font color, and form field background color allow the merchant to specify font and background information so that HTML document 202 will blend in well with the rest of merchant web page 201. The fields company logo, page heading and payment heading allows the merchant to specify information to be displayed within HTML document 202 to identify HTML document 202 as being associated with the merchant. The update button is used to forward the data input by the merchant to payment processing server 103.

An end user may authorize future payments to be made to a merchant. Such future, and possibly ongoing, payments can be made, for example, as part of a subscription to a service or publication. When payments are due, the merchant can facilitate the payments using a web document securely accessed from payment processing server 103. The web document can be directly hosted by payment processing server 103 or made available to the merchant using an inline frame placed within a merchant web page hosted by merchant server 102.

Alternatively, when payments are due, merchant server 102 can directly send a request for payment to payment processing server 103, using, for example, a hypertext transfer protocol secure (https) post. The request includes a merchant API user name, merchant API key and end user's identification (ID). The message can be prepared manually by the merchant or generated automatically, for example, by an extensible markup language (XML) or php scripting language or another available language on merchant server 102. Payment processing server 103 replies indicating whether the requested transaction was completed or denied.

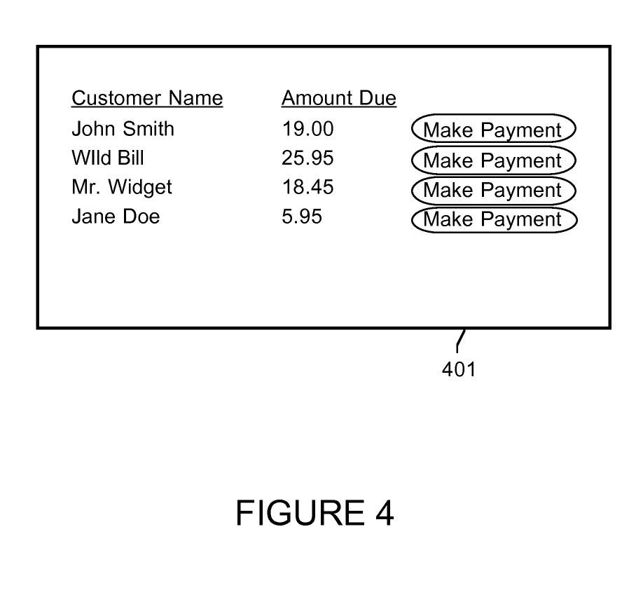

FIG. 4 shows an example of a displayed web document 401 that can be used by the merchant to make a payment previously authorized by end user 101. The web page lists customer names and amounts due. Payment can be made by selecting a corresponding payment button.

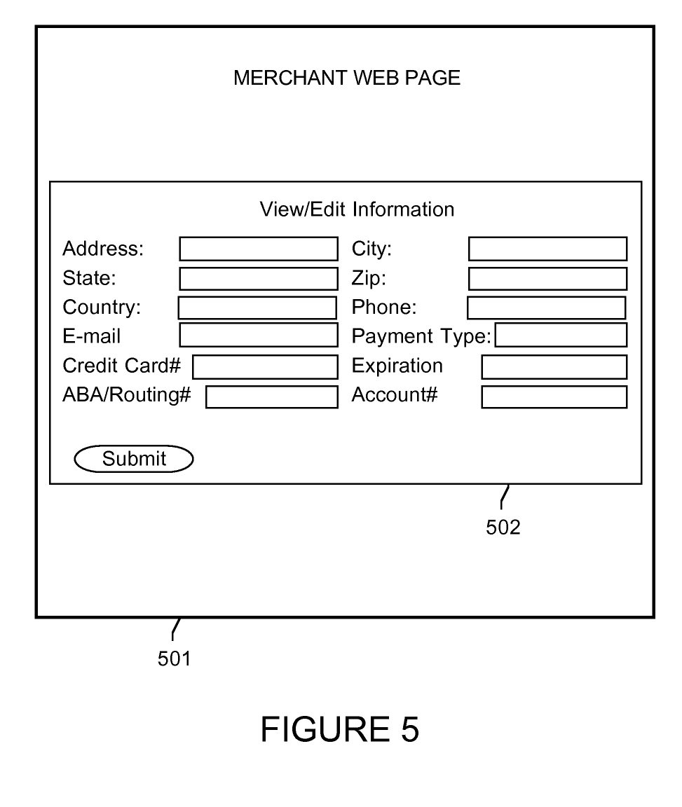

If end user 101 has previously made a purchase from the merchant and wants to update payment information, this can be accomplished by accessing a merchant web page 501, located on merchant server 102, as shown in FIG. 5. Within web page 501 is an HTML document 502 from payment processing server 103. HTML document 502 appears as an inline frame on merchant web page 501 as a result of an iframe tag embedded in the HTML code that implements merchant web page 501. When end user has finished updating payment information and selects the submit button, payment processing server 103 stores the updated information in database 104.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed:

1. A computer implemented method for conducting a payment transaction over the Internet, comprising:
presenting to an end user, by a merchant server, a merchant web page that identifies the merchant server as the source of the web page; and
presenting to the end user, by a payment processing server, a web document that requests payment information from the end user, the web document presented to the end user as an inline frame within the merchant web page.

2. A computer implemented method as in claim 1 wherein the payment information includes credit card number.

3. A computer implemented method as in claim 1 wherein the payment information includes information pertaining to electronic transfers from a bank account.

4. A computer implemented method as in claim 1 additionally comprising:
presenting to the end user, by the merchant server, a merchant web page that indicates payment was received, when payment transaction is completed successfully.

5. A computer implemented method as in claim 1 additionally comprising:
presenting to the end user, by the merchant server, a merchant web page that indicates payment was declined, when the payment transaction is unsuccessful.

6. A computer implemented method by which a payment processing server handles financial transactions over the Internet, comprising:
presenting to an end user, by the payment processing server, a web document that requests payment information from the end user, the web document being presented to the end user as an inline frame within a merchant web page; and
receiving from the end user, by the payment processing server, the payment information.

7. A computer implemented method as in claim 6 wherein the payment information includes credit card number.

8. A computer implemented method as in claim 6 wherein the payment information includes information pertaining to electronic transfers from a bank account.

9. A computer implemented method as in claim 6 additionally comprising:
when a payment transaction is successful, directing the end user, by the payment processing server, to a merchant web page that indicates payment was received.

10. A computer implemented method as in claim 6 additionally comprising:
when a payment transaction is unsuccessful, directing the end user, by the payment processing server, to a merchant web page that indicates payment was declined.

11. A computer implemented method as in claim 6 additionally comprising
presenting to a merchant, by the payment processing server, a set-up web document that allows the merchant to specify set-up information for the web document presented to the end user as an inline frame within the merchant web page.

12. A computer implemented method as in claim 6 additionally comprising
presenting to a merchant, by the payment processing server, a set-up web document that allows the merchant to specify set-up information for the web document presented to the end user as an inline frame within the merchant web page, the web set-up information including at least one of the following:
text color, background color, font type, font size.

13. A computer implemented method as in claim 6 additionally comprising
presenting to a merchant, by the payment processing server, a set-up web document that allows the merchant to specify set-up information for the web document presented to the end user as an inline frame within the merchant web page, the web set-up information including at least one of the following:
a universal resource locator (URL) field that indicates a web page where the end user will be directed when a payment made by the end user is approved;
a URL that indicates a web page where the end user will be directed when a payment made by the end user is declined.

14. A computer implemented as in claim 6 additionally comprising:
presenting to an end user, by the payment processing server, an information update web document that requests payment update information from the end user, the information update web document presented to the end user as an inline frame within an update merchant web page; and
receiving from the end user, by the payment processing server, the payment information.

15. A computer implemented method as in claim 6 additionally comprising
presenting to a merchant, by the payment processing server, a menu by which the merchant can select to receive payments preauthorized by the end user, wherein financial information for the end user is stored by the payment processing server in a database.

16. A computer implemented method by which a payment processing server handles financial transactions, comprising:
presenting to an end user, by the payment processing server, an information update web document that requests payment update information from the end user, the information update web document presented to the end user as an inline frame within an update merchant web page; and
storing in a database, by the payment processing server, payment update information received from the end user.

17. A computer implemented method as in claim 16 wherein the payment information includes at least one of the following:
credit card number;
information pertaining to electronic transfers from a bank account.

18. A distributed computing system comprising:
a merchant server, the merchant server presenting to an end user, a merchant web page that identifies the merchant server as the source of the web page; and
A payment processing server, the payment processing server presenting to the end user, a web document that requests payment information from the end user, the web document being presented to the end user as an inline frame within the merchant web page.

19. A distributed computing system as in claim 18 wherein the payment information includes at least one of the following:
credit card number;
information pertaining to electronic transfers from a bank account.

20. A distributed computing system as in claim 18 wherein when a payment transaction is completed successfully the merchant server presents to the end user a merchant web page that indicates payment was received, and wherein when a payment transaction is unsuccessful the merchant server presents to the end user a merchant web page that indicates payment was declined.

22. A distributed computing system as in claim 18 wherein when a payment transaction is completed successfully the payment processing server directs the end user to a merchant web page that indicates payment was received and wherein when a payment transaction is unsuccessful the payment processing server directs the end user to a merchant web page that indicates payment was declined.

23. A distributed computing system as in claim 18 wherein the payment processing server presents to a merchant a set-up web document that allows the merchant to specify set-up information for the web document presented to the end user as an inline frame within the merchant web page.

24. A distributed computing system as in claim 18 wherein the payment processing server presents to a merchant a set-up web document that allows the merchant to specify set-up information for the web document presented to the end user as an inline frame within the merchant web page, the web set-up information including at least one of the following:
text color;
background color;
font type;
font size;
a universal resource locator (URL) field that indicates a web page where the end user will be directed when a payment made by the end user is approved;
a URL that indicates a web page where the end user will be directed when a payment made by the end user is declined.

25. A distributed computing system as in claim 18 wherein the payment processing server presents to the end user an information update web document that requests payment update information from the end user, the information update web document presented to the end user as an inline frame within an update merchant web page.

26. A distributed computing system as in claim 18 wherein the payment processing server presents to a merchant a menu by which the merchant can select to receive payments preauthorized by the end user, wherein financial information for the end user is stored by the payment processing server in a database.

27. A payment processing system comprising:
a payment processing server that handles financial transactions, the payment processing server presenting a web document that requests payment information from the end user, the web document being presented to the end user as an inline frame within a merchant web page presented from a merchant server; and
a database, the payment processing server storing in the database payment information received from the end user.

28. A payment processing system as in claim 27 wherein the payment processing server also to the end user an information update web document that requests payment update information from the end user, the information update web document presented to the end user as an inline frame within an update merchant web page.

29. A payment processing system as in claim 27 wherein the payment processing server selects contents of the web document based on identification information that identifies the merchant, the identification information being transmitted from the merchant server to the payment processing server.

30. A payment processing system as in claim 27 wherein the payment processing server selects contents of the web document based on identification information that identifies the merchant, the identification information being transmitted from the merchant server to the payment processing server.

30. A payment processing system as in claim 27 wherein when the payment processing server presents the web document to the end user, the payment processing server also sends a session identification number to the merchant server, the payment processing server timing out a session whenever the payment processing server fails to receive a transmission with the session identification number within a predetermined amount of time.

31. A payment processing server as in claim 27 wherein upon the payment processing server receiving a request for a payment transaction to be made on behalf of the end user, the payment processing server replies to the merchant server indicating whether the payment transaction was completed or denied.

32. A payment processing server as in claim 31 wherein the request for the payment transaction is generated in one of the following ways:
automatically by the merchant server using extensible markup language (XML) or personal home page (php) scripting language;
as a result of a manual request from a merchant.
